(19) United States
(12) Patent Application Publication
(10) Pub. No.: US 2026/0106514 A1
(43) Pub. Date: Apr. 16, 2026

(54) GENERATOR ASSEMBLY

(71) Applicant: PHOELENZ PTY LTD, Brighton Le Sands, New South Wales (AU)

(72) Inventor: Tewfik George SAAD, Nowra, New South Wales (AU)

(21) Appl. No.: 19/113,306

(22) PCT Filed: Mar. 20, 2023
(86) PCT No.: PCT/AU2023/050909

§ 371 Date: Mar. 19, 2025

(30) Foreign Application Priority Data
Sep. 20, 2022 (AU) 2022902710

(51) Int. Cl. H02K 7/18; H02K 7/06; H02K 7/14; H02K 7/20

(52) U.S. Cl. CPC H02K 7/1838; H02K 7/06; H02K 7/14; H02K 7/20; H02K 2213/09

(57) ABSTRACT

A generator assembly (10) comprises a rotatable fan (12) with fan blades (14), and having blade magnets (16) at distal ends (11) of the fan blades (14). The assembly (10) further comprises a main tube (30) carrying a wire coil (32) and containing a movable magnet 34 therewithin. The main tube (30) has a recoil magnet (36) at a distal end (38) thereof which biases the movable magnet (34) towards the proximal end (40) of the main tube (30). The fan (12) in use is rotated by wind/airflow/fluid flow which causes the blade magnets (16) to interact with the movable magnet (34) causing the movable magnet (34) into a reciprocating motion within the main tube 30 through the wire coil (32), thus generating an electric current in the wire coil (32).

### FIELD OF THE INVENTION

The present invention relates to a generator assembly for generating electricity using fluid flow, such as wind flow, water flow, liquid flow and the like.

### BACKGROUND OF THE INVENTION

With climate change being a present challenge, it is desirable to provide new renewable energy options.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect, the present invention provides a generator assembly comprising:
a rotatable fan having fan blades, at least one fan blade having a blade magnet thereon,
a tube sub-assembly comprising:
a main tube having an internal cavity, a proximal end and a distal end, the main tube carrying a wire coil and containing a movable magnet therewithin, the movable magnet being able to move in the internal cavity between the proximal end and the distal end and through the wire coil, and
a biasing means to bias the movable magnet towards the proximal end of the main tube,
wherein rotation of the fan causes the blade magnet to travel adjacent the proximal end of the main tube where the blade magnet moves the movable magnet towards the distal end causing the movable magnet to move in a forward direction through the wire coil,
wherein the biasing means then moves the movable magnet towards the proximal end of the main tube causing the movable magnet to move in an opposite return direction through the wire coil, and continuous rotation of the fan causes the movable magnet into a reciprocating motion within the main tube between the distal end and the proximal end through the wire coil to generate an electric current in the wire coil.

Preferably, the biasing means is a recoil magnet disposed at the distal end of the main tube.

Preferably, the rotatable fan comprises a central hub rotatable about an axis, and two or more fan blades extending outwardly from the central hub, and each fan blade having a blade magnet.

Preferably, the fan blades include a flat rear surface having the blade magnets attached thereto.

Preferably, the blade magnets are attached to distal ends of the fan blades and the proximal end of the main tube is disposed adjacent to the distal ends of the blades.

Preferably, front surfaces of the fan blades are shaped such that fan moves with the wind or air flow and turns about the axis.

Preferably, the proximal end of the main tube is disposed adjacent to the distal ends of the blades.

Preferably, the main tube is oriented to be parallel to the axis of the hub.

Preferably, for each tube sub-assembly, the main tube carries the wire coil at a position therealong spaced from the proximal end.

Preferably, the wire coil has a central opening which is aligned with the internal cavity.

Preferably, for each tube sub-assembly, the distal end of the main tube includes a recoil magnet adjuster for adjusting the distance of the recoil magnet from the proximal end.

Preferably, for each tube sub-assembly, a proximal end cap closes the proximal end.

Preferably, for each tube sub-assembly, a first piezoelectric plate is disposed at the proximal end cap which is repeatedly impacted by the movable magnet in use to produce a first additional current.

Preferably, for each tube sub-assembly, a second piezoelectric plate is disposed within the internal cavity at the other side of the wire coil opposite to the proximal end cap such that the movable magnet 34 impact the second piezoelectric plate during its travel away from the proximal end cap to generate a second additional current.

Preferably, the fan is carried by a cowling housing having an inlet to the fan to direct wind or air flow to the fan.

In another embodiment, the blade magnet is oriented on the blade to have a pole facing away from the rotation axis of the fan, and the main tube is oriented to extend radially from the rotation axis.

In another embodiment, the generator assembly comprises a combination of axially and radially oriented main tubes, each fan including a combination of magnets facing parallel to the axis with corresponding main tubes parallel to the axis and magnets facing away from the axis with corresponding main tubes directed outward radially to the axis.

In another embodiment, the generator assembly comprises two main tubes which are disposed on opposite sides of the axis.

In another embodiment, the generator assembly comprises a starter motor to initiate rotation of the

In another embodiment, the main tubes include a plurality of spaced wire coils.

In another embodiment, the fan shape is configured for bi-directional rotation to be moved/rotated by flow in either axial backward or forward direction.

In another aspect, the invention provides a plurality of generator assemblies according to any one the above arranged in a series in that the axes of the fan hubs thereof are aligned.

In another embodiment, the magnet adjuster is a manual wind adjuster or an electric motor such as a stepper motor.

In another aspect, the invention provides a method of generating electricity, the method comprising:
causing a movable magnet to move in a reciprocal motion through a wire coil.

Other aspects of the invention are also disclosed.

### BRIEF DESCRIPTION OF THE DRAWINGS

Notwithstanding any other forms which may fall within the scope of the present invention, preferred embodiments of the present invention will now be described, by way of examples only, with reference to the accompanying drawings in which:

FIG. 1 shows a generator assembly according to a first preferred embodiment of the present invention,

FIG. 2 shows a close up of the main tube of the generator assembly,

FIG. 3 shows the proximal end cap of the main tube and the fan having magnets at distal ends thereof,

FIG. 4 is a closeup view of the front portion of the fan,

FIG. 5 shows the proximal end of the main tube with the coil cavity and the movable magnet within the main tube,

FIG. 6 is an end view of the main tube,

FIG. 7 shows the distal end of the main tube with the recoil magnet adjuster;

FIG. 8 is a front end perspective view of a generator assembly according to a second preferred embodiment of the present invention,

FIG. 9 is a side perspective view of the generator assembly of FIG. 8,

FIG. 10 is a rear end perspective view of the generator assembly of FIG. 8,

FIG. 11 is a close up view of the front end of the generator assembly of

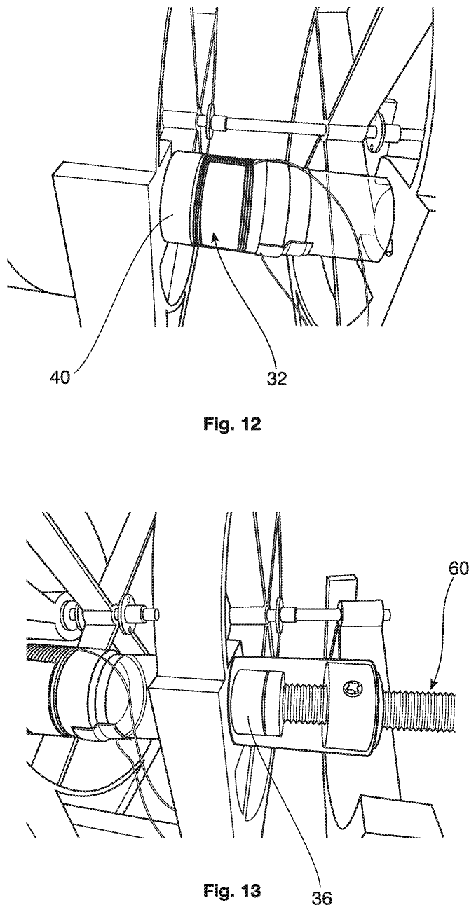

FIG. 8 showing the fans and the inlet cowling,

FIG. 12 shows the proximal end of the main tube with the coil cavity and the movable magnet within the main tube,

FIG. 13 shows the distal end of the main tube with the recoil magnet adjuster

FIG. 14 shows a generator assembly according to a third preferred embodiment of the present invention, and

FIG. 15 shows a generator assembly according to a fourth preferred embodiment of the present invention.

### DESCRIPTION OF EMBODIMENTS

It should be noted in the following description that like or the same reference numerals in different embodiments denote the same or similar features.

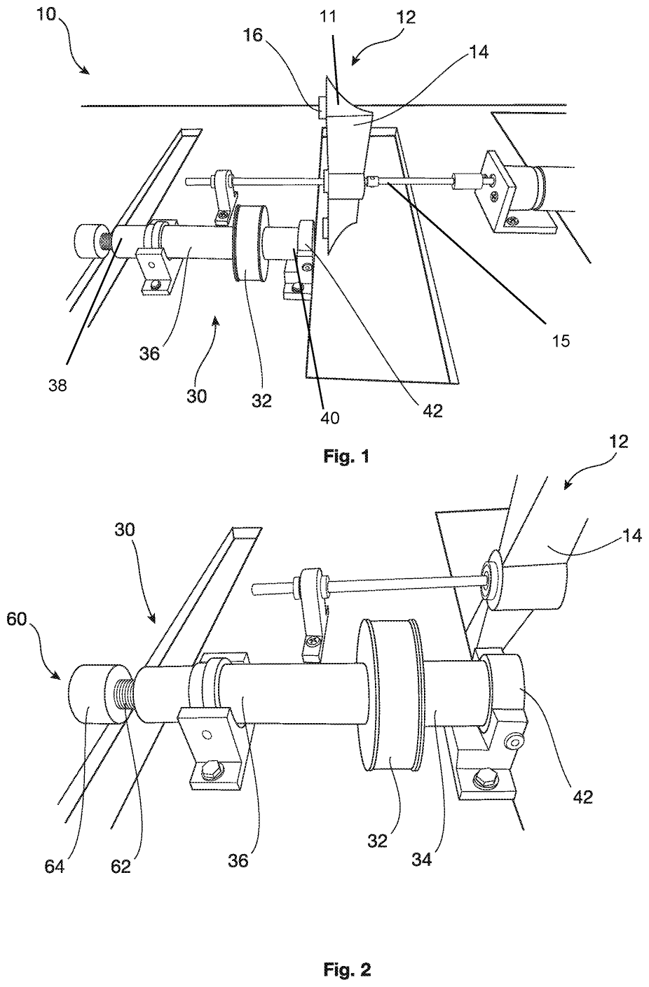

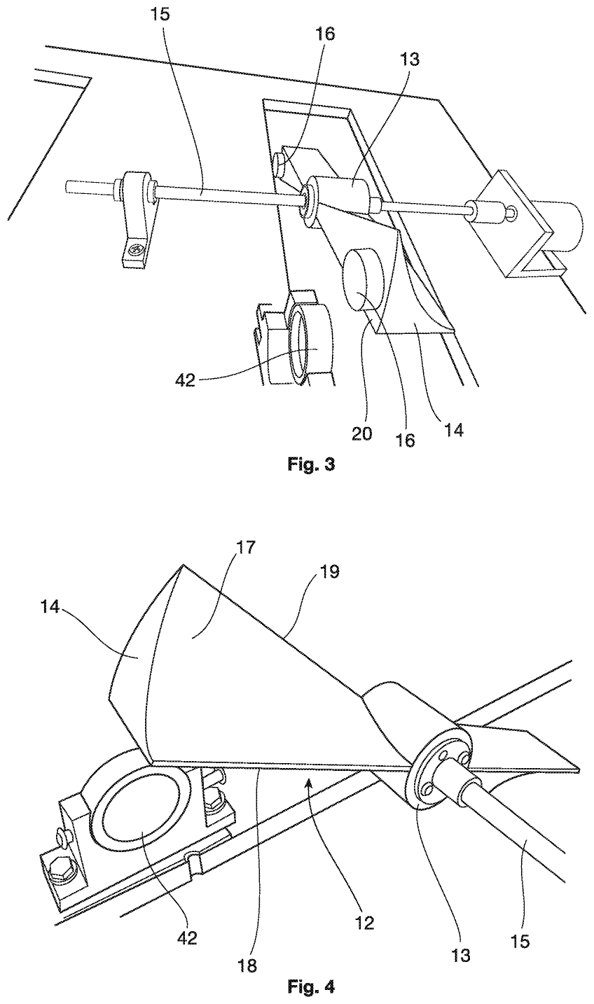

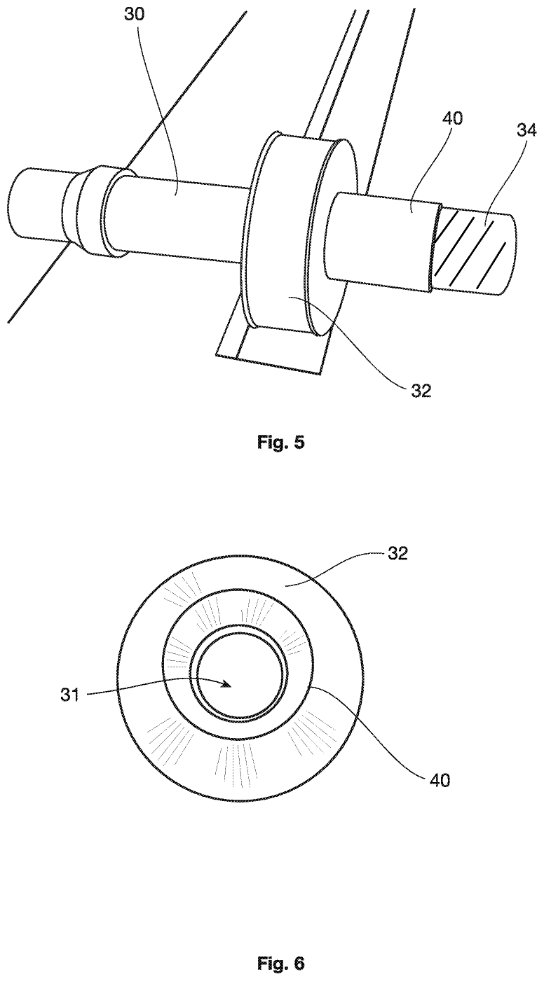

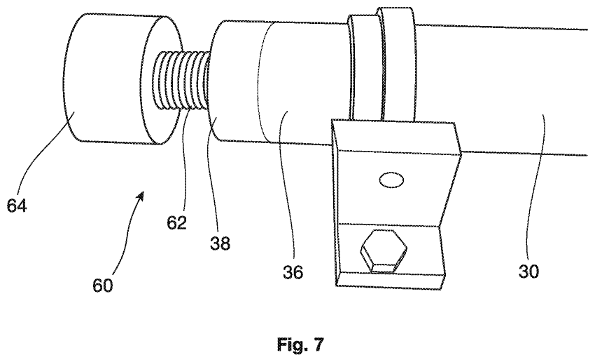

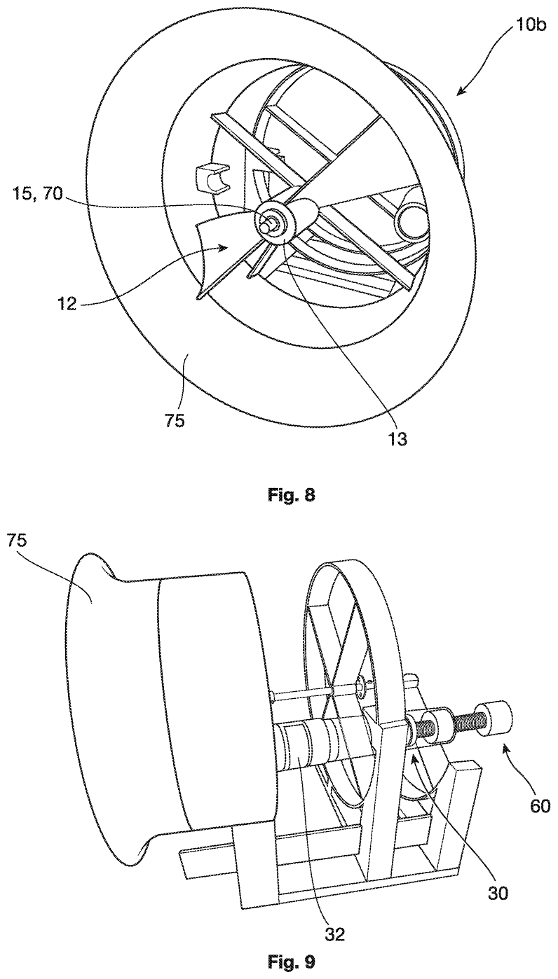

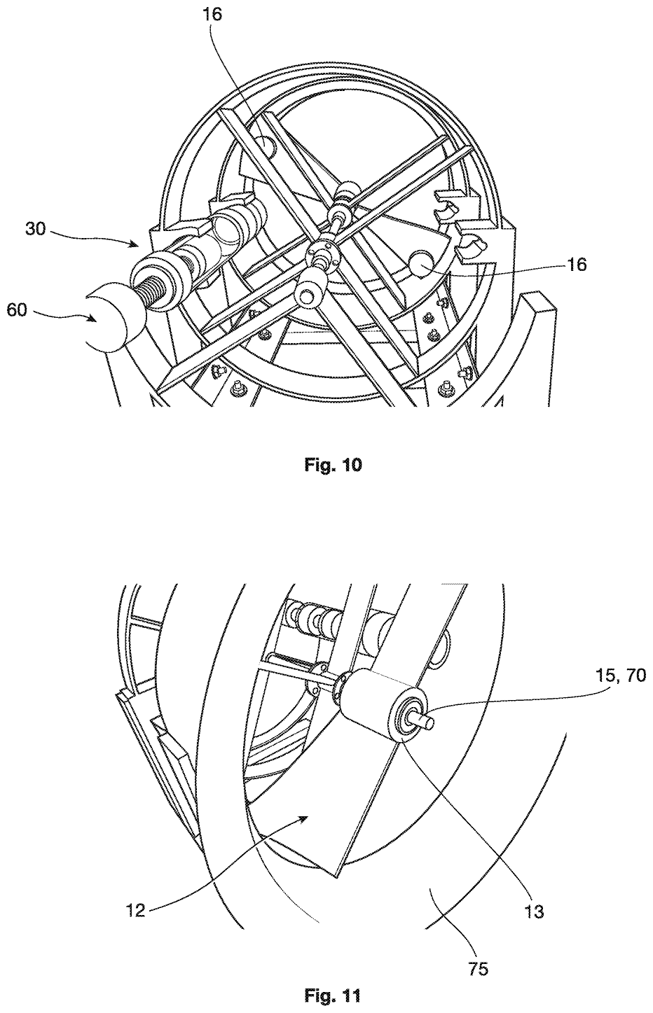

FIGS. 1 to 7 show a generator assembly 10 according to a first preferred embodiment of the present invention. The generator assembly 10 comprises a rotatable fan 12 with fan blades 14, and having blade magnets 16 at distal ends 11 of the fan blades 14. The assembly 10 further comprises a main tube 30 carrying a wire coil 32 and containing a movable magnet 34 therewithin. The main tube 30 has a recoil magnet 36 at a distal end 38 thereof which biases the movable magnet 34 towards the proximal end 40 of the main tube 30. The fan 12 in use is rotated by wind/airflow/fluid flow which causes the blade magnets 16 to interact with the movable magnet 34 causing the movable magnet 34 into a reciprocating motion within the main tube 30 through the wire coil 32, thus generating an electric current in the wire coil 32.

The rotatable fan 12 in the example embodiment comprises a central hub 13 and two fan blades 14 extending outwardly therefrom. The hub 13 is rotatable about an axis 15. The fan blades 14 include a curved front surface 17 from a leading edge 18 to a trailing edge 19. The fan blades 14 also include a flat rear surface 20 having the blade magnets 16 attached to distal ends thereof. The front surfaces 17 are shaped such that fan 12 is moved by the wind or air flow or liquid flow and rotates about the axis 15.

The main tube 30 comprises an elongate hollow body having an internal cavity 31, a proximal end 40 and a distal end 38. The proximal end 40 is disposed adjacent to the distal ends 11 of the blades 14, and the main tube 30 is oriented to be parallel to the axis 15 of the hub 13.

The main tube 30 carries the wire coil 32 at a position therealong spaced from the proximal end 40. The wire coil 32 has a central opening which is aligned with the internal cavity 31. The movable magnet 34 is disposed within the internal cavity 31 and is free to move therewithin between the proximal end 40 and the distal end 38, and thus through the central opening of the wire coil 32. A proximal end cap 42 closes the proximal end 40.

The distal end 38 of the main tube 30 includes the recoil magnet adjuster 60. The adjuster 60 includes a threaded rod 62 having the recoil magnet 36 at one end and a handle 64 at another end. Rotation of the handle 64 adjusts the position of the recoil magnet 36 along the main tube 30, that is, the distance of the recoil magnet 36 from the proximal end 40.

The recoil magnet 36 is used to bias/repel the movable magnet 34 towards the proximal end 40 against the proximal end cap 42. The blade magnets 16 are disposed such that they will travel across and adjacent to the proximal end cap 42, such that the blade magnets 16 interact with the movable magnet 34 and pushes/repels the movable magnet 34 away from the proximal end cap 42.

For example, the recoil magnet 36 can have its north pole oriented towards the proximal end cap 42. The movable magnet 34 can have its north pole oriented towards the recoil magnet 36 and its south pole oriented towards the proximal end cap 42. The blade magnets 16 can then have their south poles oriented towards the proximal end cap 42.

When wind or air flow or liquid flow is applied to the fan 12, the fan 12 rotates which moves the blade magnets 16 across the proximal end cap 42 at intervals. During these intervals, the respective blade magnet 16 adjacent the proximal end cap 42 pushes/repels the movable magnet away from the proximal end cap 42, and causes the movable magnet 34 to travel through the wire coil 32. After the blade magnet 16 passes, the recoil magnet 36 returns/repels the movable magnet 34 back to its original position adjacent to the proximal end cap 42 during which the movable magnet 34 moves through the wire coil 32 in the opposite direction.

Continuous rotation of the fan 12 causes reciprocating motion of the movable magnet 34 through the wire coil 32, thus generating an electric current in the wire coil 32 via electromagnetic induction. The strength of the magnets 16, 34 and 36 can be

Electromagnetic induction works based on Faraday's law of induction. It involves the relative motion (rotary or linear) of a magnet to a coil (electromagnet) which causes the change/interruption of the magnetic field (flux) linked with a coil by the magnet, to produce an electromotive force (e.m.f)/current. The figure below shows the linear motion of the magnet into and out of the coil.

The magnitude of electricity generated depends on the strength of the magnetic field, velocity of the relative motion of a magnet to a coil, as well as the number of turns of coil. The electromagnetic induction within a generator initiates via the rotary or linear movement of its specific part by the kinetic energy within the kinetic energy source (system).

The rotary electricity generator is more common and established in kinetic energy harvesting. Fleming's right-hand rule can be used to identify the direction of the induced current. In the case of the rotary electricity generator, the direction of the induced current depends on the orientation of the rotating conductor plate. The magnitude of the induced current depends on the deflection angle of the magnetic field caused by the rotation of the conductor plate. The larger the deflection angle, the larger the magnitude of the current (e.m.f). Eq. (3) shows the formula to determine the magnitude of induced current. Based on Lenz's law, the negative sign indicates the opposing force which counteracts the motion force. Lenz's law works in accordance with Newton's 3rd law and law of energy conservation

Magnitude of e.m.f, volt=−N
Where N is the number of turns
0 is the magnetic flux (external magnetic field multiplied by the area of the coil) t is the time

In a modified embodiment of the assembly 10, a first piezoelectric plate is disposed at the proximal end cap 42 which is repeatedly impacted by the movable magnet 34 in use to produce an additional current. A second piezoelectric plate can also be added within the cavity 31 at the other side of the wire coil 32 opposite to the proximal end cap 42, such that the movable magnet 34 will impact the second piezoelectric plate during its travel away from the proximal end cap 42 and then the first piezoelectric plate during its travel back to the proximal end cap 42. This provides the generation of additional currents. The currents generated via the wire coil 32 and the piezoelectric plates can then be measured, collected or used as desired.

Piezoelectric mechanism is a phenomenon when the mechanical strain and (or) stress applied on the electroactive material, there is an electric charge generated within the material. The magnitude of mechanical strain and(or) stress applied to the electroactive material is directly proportional to the magnitude of electrical polarization within the material. The piezoelectric transducer consists of electroactive materials for high electromechanical coupling. For examples, Barium Titanate (BaTiO3), Zinc Oxide (ZnO), and Lead Zirconate Titanate (Pb[ZrxTi1−x]O3), and polymer-ceramic composite (PVDF-PZT) which then replaces ceramics due to its flexibility, inexpensiveness, and durability. The 31 mode is typically used although has a lower coupling coefficient. Piezoelectric works based on either voltageconstrain or charge-constrain approach. The consecutive equations for a piezoelectric material, calculation formula of the voltage source, piezoelectric damping coefficient, optimum resistance, and maximum power was presented by Kazmierski.

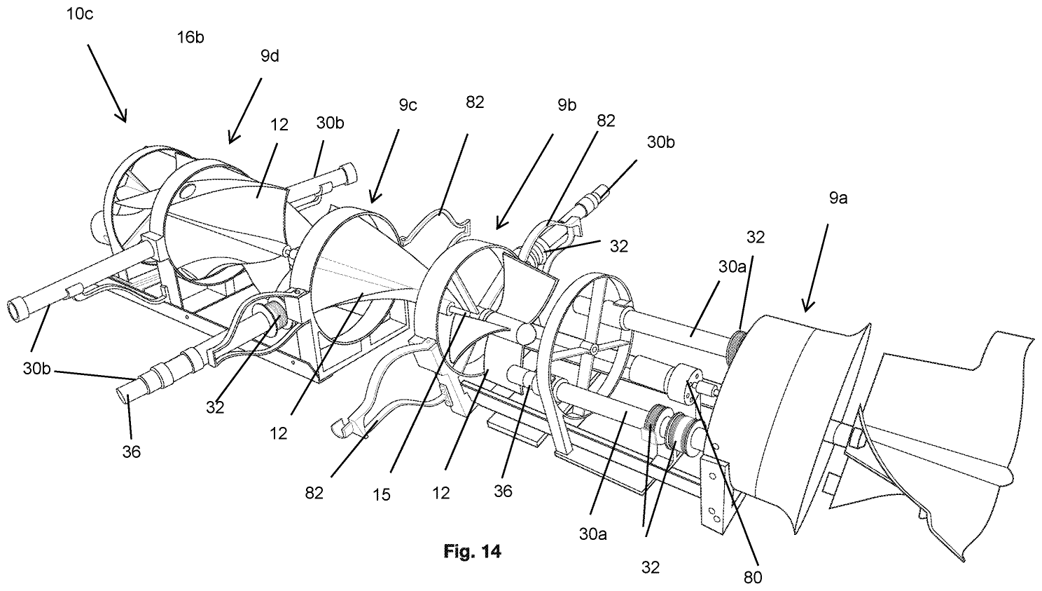

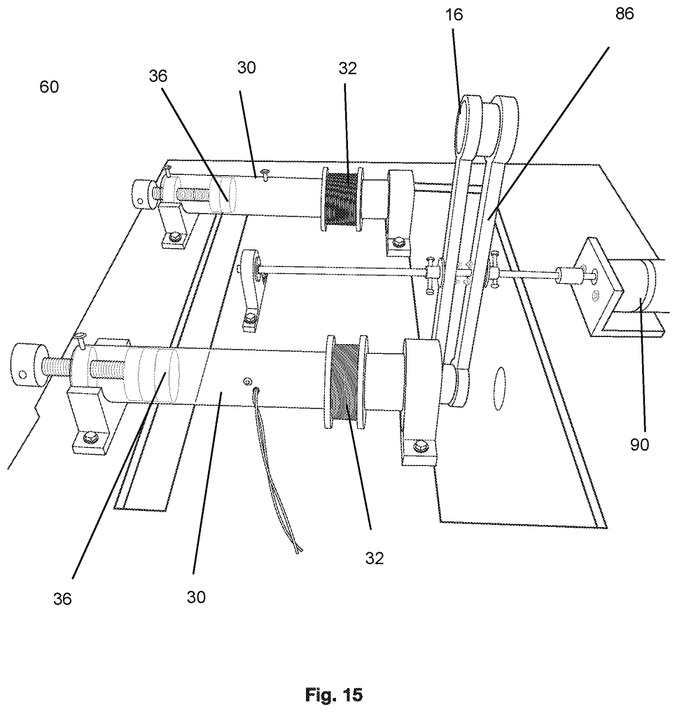

FIGS. 8 to 13 show a generator assembly 10b according to a second preferred embodiment of the present invention which has similar parts as the first embodiment. The generator assembly 10b also comprises the rotatable fan 12 having blade magnets 16 at distal ends 11 of the fan blades 14. The assembly 10 further comprises the main tube 30 carrying the wire coil 32 and containing the movable magnet 34 therewithin. The main tube 30 also has the recoil magnet 36.

The rotatable fan 12 in this example also comprises a central hub 13 and two fan blades 14 extending outwardly therefrom. The hub 13 is rotatable about an axis 15 via a shaft 70 carried by a cowling housing 75. The cowling housing 75 forms an inlet to the fan 12 to direct wind or air flow or liquid flow to the fan 12 for turning about the axis 15. The fan 12 can have any desired number of blades such as 3 or more blades each having a blade magnets 16 at distal ends thereof, or only having blade magnets 16 at every other blade. Balancing weights can be added to the other blades as needed.

The main tube 30 as per the first embodiment is disposed parallel to and offset from the axis 15 such that the proximal end 40 of the main tube 30 is disposed adjacent to the distal ends of the blades 14 having the blade magnets 16. Having the main tube 30 offset from the axis 15 of the fan 12 provides for the main tube minimizing interference with the airflow through the fan 12.

The main tube 30 carries the wire coil 32. The movable magnet 34 is disposed within the internal cavity 31 and is free to move therewithin and through the central opening of the wire coil 32. The distal end 38 of the main tube 30 also includes the recoil magnet adjuster 60.

As per the first embodiment, when wind or air flow is applied to the fan 12, the fan 12 rotates which moves the blade magnets 16 across the proximal end cap 42 at intervals. During these intervals, the respective blade magnet 16 adjacent the proximal end cap 42 pushes the movable magnet away from the proximal end cap 42, and causes the movable magnet 34 to travel through the wire coil 32. After the blade magnet 16 passes, the recoil magnet 36 returns the movable magnet 34 back to its original position adjacent to the proximal end cap 42 during which the movable magnet 34 moves through the wire coil 32 in the opposite direction.

Continuous rotation of the fan 12 causes reciprocating motion of the movable magnet 34 through the wire coil 32, thus generating an electric current in the wire coil 32 via electromagnetic induction.

The embodiments describe a fan which in the current invention includes any variation thereof of a component having a rotatable hub with blades, such as vanes, impellers, turbines, rotors, and similar which can be rotated by wind, airflow, water flow, liquid flow and the like.

In other embodiments, the fan can be replaced by an actively rotated component such as a wheel or flywheel. This embodiment for example is where the generator assembly is an addition to an internal combustion engine.

In another possible modification, the assembly 10 can include two or more main tubes 30 each carrying a wire coil 32 and containing a movable magnet 34. Each main tube can also have the piezoelectric pads at the ends of the travel of the movable magnet. The main tubes for example can be disposed at opposite positions on the periphery of the fan blade movement circles. The main tube can also include two or more spaced wire coils. Such embodiments can produce more current. The assembly can also include additional equipment such as a voltage regulator and current regulator to regulate the electricity being produced.

The magnets can also be disposed at other portions of the blades such as at the midportions thereof. A separate respective main tube can be provided to correspond to each blade magnet. Two or more magnets can be provided for each blade, such as one at the distal end and one at the mid-portion, with corresponding main tubes being provided.

The electric generator of the above embodiments can be used charge batteries of any electric mobile vehicle as it moves through the air or water. The generator assembly 10 for example can be installed above the roof or hood of a car vehicle upon which the fan 12 will rotate with airflow as the vehicle moves. The generator assembly 10 can also be installed integrated as part of the vehicle body. Two assemblies 10 for example can be installed on each side of the vehicle body.

Other possible vehicles include trucks, bikes, boats, trains, planes, etc. as long as the vehicle is moving. The electric generator assembly can be used to charge vehicle batteries, capacitors, or run low current electronics such as heating, audio, lighting, etc. The vehicle can be an electric vehicle or an internal combustion engine vehicle.

The generator assembly has fewer moving parts and requires less maintenance.

The generator assembly 10 can also be adapted for use in other applications where other forces can be used to rotate the fans 12. The assembly 10 can be used in tidal applications using the water flow (current) to rotate the blades and produce electricity. All segments are waterproofed depending on weather applications. In this embodiment, the fans 12 can be replaced by impeller or other rotor suited for fluid applications.

This generator can also be used on flywheel applications where the rotating fan will be in the form of a rotating flywheel, mechanical or otherwise, to produce electricity. This generator can also be attached to a low torque motor to generate electricity instead of the blade(s).

The generator assembly can also be used in static applications where it is installed in high wind positions such as a building roof. The fans can also be replaced by vertical blade impellers. The fan magnets and main tubes in these embodiments will be positioned at suitable distal locations.

The generator assembly includes in the main tube and on opposite ends of the coil are two piezoelectric pads which add duality to the electrical generation of the device.

This generator can be scalable, capable of producing LV, MV and HV voltage quantities.

This new electrical motor/generator assembly recreates the original motor design to incorporate the blade with the actual motor/generator assembly. Having the ‘motor’ (main tube) positioned away from the centre gives excellent airflow throughout the body of the turbine.

Each revolution of the turbine/fan produces electricity. This is efficient as it does not need to have a high rpm to produce electricity compared to other generators.

This generator can work in low and high rpm applications. The generator can be adjusted to produce electricity at different vehicle speeds.

Although a preferred embodiment of the present invention has been described, it will be apparent to skilled persons that modifications can be made to the embodiment shown.

The number, location, and position of the main tubes, coils, piezo plates, and magnets can all be adjustable or movable as needed to suit different applications. The blade magnet for example can be positioned at a mid-portion of the blade rather than at the distal end.

In another possible modification, the blade magnet can oriented on the blade to be parallel and perpendicular to the rotation axis of the fan (e.g. perpendicular to the blade rear surface). In this embodiment, the main tube is oriented to extends radially from the rotation axis. The blade magnet thus repels the movable magnet outwardly from the central rotation axis. The main tube can be disposed in any radial position, horizontally, vertically, or any angular radial orientation to the rotation axis.

FIG. 14 shows a generator assembly 10c according to a third preferred embodiment of the present invention. The generator assembly 10c comprises a plurality of generator subassemblies 9a to 9d arranged in a series.

Each generator sub-assembly 9 comprises a rotatable fan 12 with blade magnets in the fan blades thereof. Each sub-assembly 9 further comprises at least one main tube 30 carrying a wire coil 32, the movable magnet 34 therewithin, and the recoil magnet 36 at the distal end 38 thereof. Each generator sub-assembly 9 thus functions in a similar manner to the generators 10 and 10b above, and can similarly include the piezoelectric plates for additional current generation.

The sub-assembly 9a includes two main tubes 30a which are oriented to be parallel to the axis 15 of the hub 13. The main tubes 30a are disposed on opposite sides of the axis 15. The sub-assembly 9a also includes a motor 80 which can be used as a starter motor to initiate rotation of the fans 12. Air flow or liquid flow can then take over rotation of the fans 12. The motor 80 can also function as an additional generator once the fans 12 are being rotated by air flow or fluid flow. The main tubes 30 can also include a plurality of spaced wire coils 12 as shown.

Sub-assemblies 9b to 9d show arrangements where the blade magnet is oriented on the fan blades to have a pole (side) facing away from the rotation axis of the fan (e.g. disposed on the outer periphery portions of the fan blades). In these embodiments, the main tubes 30b are oriented to extend radially outwardly relative the rotation axis 15. The blade magnets thus repel the movable magnets outwardly from the central rotation axis 15. The main tubes 30b are supported by carriers 82 and can be disposed in any radial position, horizontally, vertically, or any angular radial orientation to the rotation axis.

The Sub-assemblies 9b to 9d each show 1 or more radially oriented main tubes 30b, with the sub-assemblies 9b to 9d differing in fan shape. The fan shape can be made to be bidirectional, that is, to be moved/rotated by flow in either axial direction (backward or forward). This is ideal for example for tidal applications. The magnets 16 can be imbedded into the blade to reduce friction such as shown in magnet 16b.

The generator sub-assemblies 9a to 9d are arranged in a series in that the axes 15 of the fan hubs thereof are aligned. Air flow or fluid flow will thus engage the fans in series. The axis shafts of the fans can be connected to each other or be independent from each other.

FIG. 15 shows a generator assembly according to a fourth preferred embodiment of the present invention. In this embodiment, the fan is replaced by a rotatable arm 86 having the magnets 16 at distal ends thereof. The arm 86 is rotated by a motor 90 which is powered by a battery. The recoil magnet adjuster 60 can alternatively be a motor pushing a plunger for the recoil magnet.

The above embodiments thus show generators can initially work by “starter motor” using one-directional bearing in rotation with wind flow rotation to overcome magnetic torque to engage the generator magnets. Then once the rotor blade is rotating, the attached shaft just spins inside the bearing coupling unopposed, generating electricity under the forces of wind/water/etc.

No “starter motor” is needed when using gas/fluid/water pipe flow. Movable magnet is positioned outwardly, then moved inwardly in an oscillating manner.

The movable recoil magnet can be controlled with a motor to adjust the position of the recoil magnet using screw or linear method.

Generator assembly produces a “knocking sound” (impact noise) while generating at low speeds and runs near silent” at high speeds, (impact-piezo to vibration-resonance)

The assembly can include a combination of both axially and radially oriented electricity coil apparatus. Each fan can include a combination of magnets facing parallel to the axis (with corresponding main tubes parallel to the axis) and magnets facing away from the axis (with corresponding main tubes directed outward radially to the axis).

A coil plunger can be connected to the rebound magnet, screw threaded sleeve, sliding mechanism attached to motor and movable magnet make up END of coil arrangement. The copper coil side makes up FRONT of coil arrangement.

Coil arrangements can have one or more coils windings on/along the coil arrangement main tube.

Coil arrangements around/internal can be in multiples of 2 or 3 etc. (i.e. 2 coil configuration, 4 coil, 6 coil, 8,10,12 etc.)

One (1) or more magnets can be spaced along side each blade length to coincide with each individual coil arrangement.

Blade configurations in the blade can be either Axial, Radial and combination of both, i.e. magnets can be oriented in the blade to repel the movable magnet in the axial and radial axis.

For Tidal turbines, the magnet(s) in the blade(s) can be orientated adjacent to other magnets rotating on a radial axis repelling each individual coil arrangement positioned on the diameter of the rotating blade axis. The Tidal Generator Assembly variant can be either with or without the piezo generators and will have dual direction blades.

Generator can generate electricity with or without the start motor. When the end magnet is at the most extreme in the coil assembly, the torque will be low enough for the turbine to rotate.

It is to be noted that the invention can also be applied in other configurations, such as the fan being replaced by an impeller having magnets, or a flywheel or other rotated part having magnets.

In another possible modification, the main tubes can be oriented vertically and the return biasing means can be gravity, with the return magnet being removed. be noted in the following description that like or the same reference numerals in different embodiments denote the same or similar features.

I claim:

1. A generator assembly, comprising:
a rotatable fan having fan blades, at least one fan blade having a blade magnet thereon,
a tube sub-assembly comprising:
a main tube having an internal cavity, a proximal end and a distal end, the main tube carrying a wire coil and containing a movable magnet therewithin, the movable magnet being able to move in the internal cavity between the proximal end and the distal end and through the wire coil, and
a biasing means to bias the movable magnet towards the proximal end of the main tube,
wherein rotation of the fan causes the blade magnet to travel adjacent the proximal end of the main tube where the blade magnet moves the movable magnet towards the distal end causing the movable magnet to move in a forward direction through the wire coil,
wherein the biasing means then moves the movable magnet towards the proximal end of the main tube causing the movable magnet to move in an opposite return direction through the wire coil, and continuous rotation of the fan causes the movable magnet into a reciprocating motion within the main tube between the distal end and the proximal end through the wire coil to generate an electric current in the wire coil.

2. The generator assembly of claim 1, wherein the biasing means is comprised of a recoil magnet disposed at the distal end of the main tube.

3. The generator assembly of claim 1, wherein the rotatable fan comprises a central hub rotatable about an axis, and two or more fan blades extending outwardly from the central hub, and wherein each fan blade has a blade magnet.

4. The generator assembly of claim 3, wherein the fan blades are each comprised of a flat rear surface having the blade magnets attached thereto.

5. The generator assembly of claim 1, wherein the blade magnets are attached to distal ends of the fan blades and wherein the proximal end of the main tube is disposed adjacent to the distal ends of the blades.

6. The generator assembly of claim 4, wherein front surfaces of the fan blades are shaped such that fan moves with the wind or air flow and turns about the axis.

7. The generator assembly of claim 3, wherein the main tube is oriented to be parallel to the axis of the hub.

8. The generator assembly of claim 1, wherein for each tube sub-assembly, the main tube carries the wire coil at a position therealong spaced from the proximal end.

9. The generator assembly of claim 1, wherein the wire coil has a central opening which is aligned with the internal cavity.

10. The generator assembly of claim 2, wherein for each tube sub-assembly, the distal end of the main tube comprises a recoil magnet adjuster for adjusting the distance of the recoil magnet from the proximal end.

11. The generator assembly of claim 1, wherein for each tube sub-assembly, a proximal end cap closes the proximal end.

12. The generator assembly of claim 11, wherein for each tube sub-assembly, a first piezoelectric plate is disposed at the proximal end cap which is repeatedly impacted by the movable magnet in use to produce a first additional current.

13. The generator assembly of claim 12, wherein for each tube sub-assembly, a second piezoelectric plate is disposed within the internal cavity at the other side of the wire coil opposite to the proximal end cap such that the movable magnet impacts the second piezoelectric plate during its travel away from the proximal end cap to generate a second additional current.

14. The generator assembly of claim 1, wherein the fan is carried by a cowling housing having an inlet to the fan to direct wind or air flow to the fan.

15. The generator assembly of claim 1, wherein the blade magnet is oriented on the blade to have a pole facing away from the rotation axis of the fan, and wherein the main tube is oriented to extend radially from the rotation axis.

16. The generator assembly of claim 1, further comprising:
a combination of axially and radially oriented main tubes, each fan including a combination of magnets facing parallel to the axis with corresponding main tubes parallel to the axis and magnets facing away from the axis with corresponding main tubes directed outward radially to the axis.

17. The generator assembly of claim 1, further comprising:
two main tubes which are disposed on opposite sides of the axis.

18. The generator assembly of claim 1, further comprising:
a starter motor to initiate rotation of the fan.

19. The generator assembly of claim 1, wherein the main tubes comprise a plurality of spaced wire coils.

20. The generator assembly of claim 1, wherein the fan has a shape configured for bi-directional rotation to be moved/rotated by flow in either axial backward or forward direction.

21-23. (canceled)
